(19) United States
(12) Patent Application Publication
(10) Pub. No.: US 2004/0095220 A1
(43) Pub. Date: May 20, 2004

(54) Transformer using coil modules and related manufacturing method thereof

(76) Inventors: Ming Yeh, Pan Chiao City (TW); Steven Wu, Pa Te City (TW); Anthony Du, Taipei City (TW)

Correspondence Address: HARNESS, DICKEY & PIERCE, P.L.C., P.O. BOX 828, BLOOMFIELD HILLS, MI, 48303, US

(21) Appl. No.: 10/701,246

(22) Filed: Nov. 4, 2003

Related U.S. Application Data
(63) Continuation-in-part of application No. 10/304,811, filed on Nov. 26, 2002.

(30) Foreign Application Priority Data
Nov. 15, 2002 (TW) 091133556
Mar. 31, 2003 (TW) 092107308

(51) Int. Cl. H01F 27/02

(52) U.S. Cl. 336/83

(57) ABSTRACT

A coil module applied in a transformer. The coil module includes at least one conductive wire and an insulating encapsulator. A portion of the conductive wire is wound into coils of a certain loop number. The coils are encapsulated by the insulating encapsulator. A metal core is provided when manufacturing a transformer. Desired coil modules are selected and installed onto the transformer so as to surround the metal core of the transformer. The coil modules are thus connected in series or in parallel for forming a desired specification of the transformer.

### CROSS-REFERENCE TO RELATED APPLICATION

This application is a continuation-in-part of U.S. application Ser. No. 10/304,811 filed on Nov. 26, 2002, hereby incorporated by reference as it fully set forth herein.

### FIELD OF THE INVENTION

The present invention relates to transformers. More particularly, the present invention relates to coil modules and transformers which use the coil modules.

### DESCRIPTION OF RELATED ART

Coil elements are widely used in transformers and other electronic devices. However, coiling procedures often take too much time and become too complicated. Besides, implicit dangers such as accidental fires or electronic shocks might occur because of incautious manufacturing or usage.

Please refer to FIG. 1(a), which shows a schematic cross-sectional view of a traditional transformer 10 and coils thereon. The transformer 10 has a bobbin 101, pins 102, a metal core 103, insulation tapes 104, 105, and coils 106.

The bobbin 101 supports the pins 102 and the metal core 103. The insulation tapes 104 are used so that the positions of the coils 106 follow certain safety standards. The coils 106 are coiled in sequence one after another until all necessary coils 106 are installed on the bobbin 101. Each coil 106 has two wires connected to the pin 102 for connecting to other elements in certain applications. The tapes 105 are provided so that the coils 106 of different sets keep proper distance.

Please refer to FIG. 1(b), which shows a schematic, cross-sectional view of another traditional transformer 11. Similarly, the transformer 11 has a bobbin 111, pins 112, a core 113, insulation layers 114 and coils 116.

The bobbin 111 supports the pins 112, the core 113, and the insulation layers 114. The coils 116 are coiled on the bobbin 111, one layer after another. In this example, four coil layers 1161, 1162, 1163, 1164 have different coil loops for performing two sets of electric voltage transformation. The coil layers 1161 and 1163 are used to function as primary coils of the transformer 11 for inputting electric voltage, and the layers 1162 and 1164 are used to function as secondary coils of the transformer 11 for outputting the resultant electric voltage.

The coiling procedures in both examples in FIG. 1(a) and FIG. 1(b) are slow because the coil wires are wound one layer after another. Incautious operators in a factory may make mistakes regarding loop number of coils for some layers. However, coils of other layers need to be unwound first before correcting the loop number of coils of the faulty layer.

Such coiling methods are also imprecise. In the example of FIG. 1(a), the thickness of tapes 104 and 105 are difficult to control. In FIG. 1(b), the insulation layers 114 take up unnecessary space and increase the size of the transformer 11. Also, coil wires may have different lengths even if the coil loops are the same when the coils are not neatly wound. Besides, coils are easily broken or fractured during winding, particularly when the bobbin structure is complicated like the one 111 shown in FIG. 1 (b).

Therefore, there are still many problems for manufacturing transformers.

### SUMMARY OF THE INVENTION

According to one aspect of the present invention, a coil module is disclosed. The coil module has a conductive wire and an insulating encapsulator. The conductive wire has a portion wound into coils. The loop number of the coils is selected from a predetermined set. The coils define a coil opening. The insulating encapsulator encapsulates the coils and defines a core opening. An outline of the core opening is within the coil opening. In addition, in order to improve heat dissipation, a certain amount of heat conductive powder is added to the encapsulator.

According to another aspect of the present invention, a transformer using such coil modules is disclosed. In the embodiment, a metal core is provided for manufacturing the transformer. Next, coil modules of necessary coil loops are selected. These coil modules are installed so that the core opening of the coil module surrounds the metal core. Besides, these coil modules are arranged as a stack. The coils of two adjacent coil modules are separated by the insulating encapsulators of the two adjacent coil modules. Besides, in order to satisfy certain requirements, a number of the coil modules in the transformer are further connected in parallel or in series.

According to another aspect of the present invention, another type of coil module is provided and such type of coil module can be used in transformers. Multiple such coil modules are not stacked one on another vertically. Instead, these coil modules are horizontally placed in a substantially same plane, and outer coil modules surround inner coil modules.

According to another aspect of the present invention, the coil modules arranged vertically and horizontally are mixed together in a transformer.

According to another aspect of the present invention, a method for manufacturing coil modules is disclosed. Metal film is patterned by stamping process or other mechanical process at first. Then, the patterned metal film is folded as the conductive line of the coil modules mentioned above.

The procedure of manufacturing transformers is therefore simplified and flexible. Comparing to prior art,the coil modules are stacked directly without placing additional insulator so that the height of the transformer is reduced. Furthermore, the height of the transformer is even smaller if the coil modules are arranged horizontally. The insulating encapsulator also protects the coils from damage by manufacturing or usage. Therefore, the present invention provides a nice solution for coiling in transformers that is flexible, improves quality and has low manufacturing cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1(a) is a schematic, cross-sectional view of a conventional transformer;

FIG. 1(b) is a schematic, cross-sectional view of another conventional transformer;

FIG. 2(a) is a schematic view of an embodiment of a coil module according to the present invention;

FIG. 2(b) is side view of FIG. 2(a);

FIG. 3(a) and FIG. 3(c) are schematic views illustrating steps for installing a coil module according to the present invention;

FIG. 4 is a flowchart for installing coil modules according to the present invention;

FIG. 5(a) shows a schematic view of part of a transformer using coil modules according to the present invention;

FIG. 5(b) shows a top view of FIG. 5(a);

FIG. 6(a), FIG. 6(b), FIG. 6(c), FIG. 6(d), FIG. 6(e), FIG. 6(f), and FIG. 6(g) schematically illustrate other embodiments of coil modules according to the present invention;

FIG. 7(a) schematically illustrates coil modules according to the present invention in series connection;

FIG. 7(b) schematically illustrates coil modules according to the present invention in parallel connection;

FIG. 8(a) shows a coil pattern;

FIG. 8(b) shows a conductive layer;

FIG. 8(c) shows a coil module made from FIG. 8(b) according to the coil pattern of FIG. 8(a);

FIG. 9 is a flowchart for manufacturing the coil module in FIG. 8(c); and

FIG. 10 schematically illustrates another embodiment of a transformer according to the present invention.

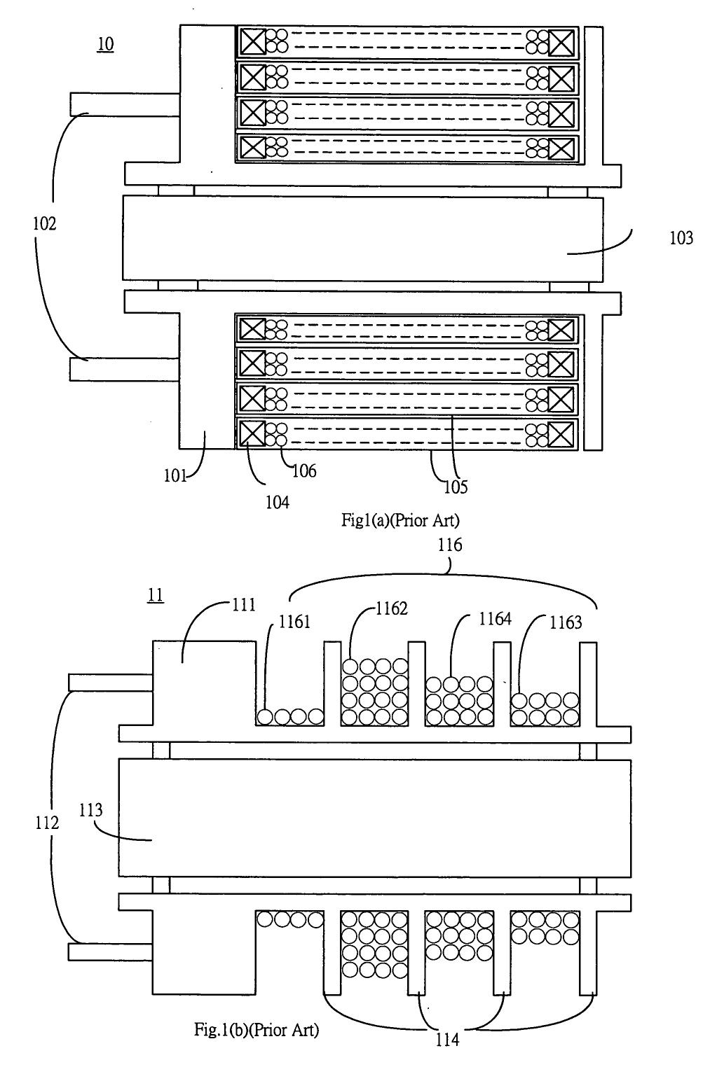

### DESCRIPTION OF THE PREFERRED EMBODIMENTS

### FIRST PREFERRED EMBODIMENT

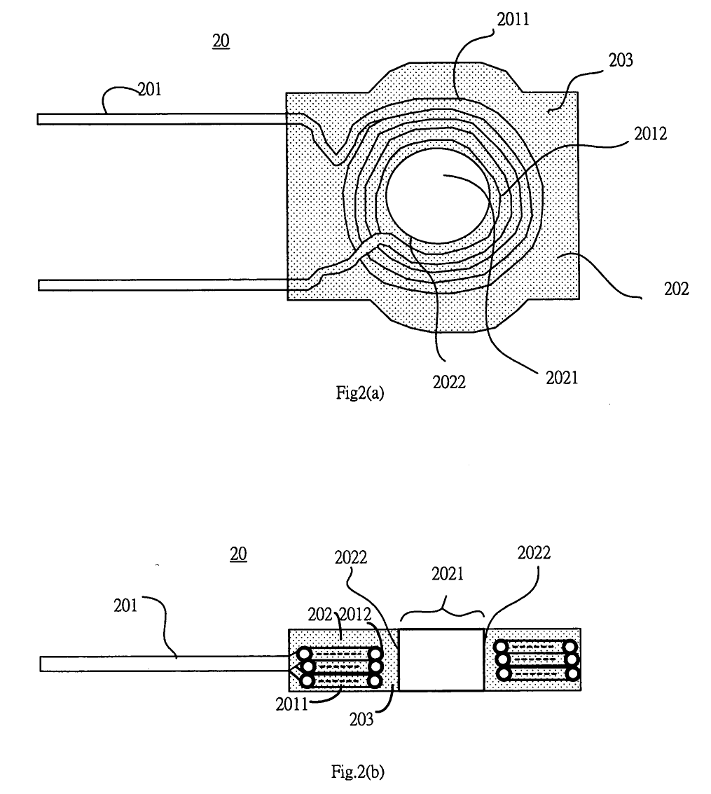

Please refer to FIG. 2(a) and FIG. 2(b), which show different views of a coil module 20 according to the present invention. FIG. 2(b) is the side view of FIG. 2(a). The coil module 20 has a conductive wire 201. An enamel-insulated wire is an example of the conductive wire 201. The conductive wire has a portion wound into coils 2011 of a loop number, and the loop number is selected from a predetermined set. In this example, the loop number of the coils 2011 is 4, which is selected from a predetermined set of {2.5, 3, 4, 5, 10, 20}. The designer can choose the predetermined set. With such design, manufacturers are able to produce a large number of the coil modules with certain loop numbers in advance to cost down. Furthermore, certain types of such coil modules are made as standard elements for other manufactures to build transformers of their requirements.

In addition to the conductive wire 201, the coil module 20 also has an insulating encapsulator 202. The insulating encapsulator 202 encapsulates the coils 2011 of the conductive wire 201. The coils 2011 define a coil opening 2012. In addition, the insulating encapsulator 202 defines a core opening 2021, and the outline 2022 of the core opening 2021 is within the coil opening 2012.

In this embodiment, the insulating encapsulator 202 can be made of plastic material. Thermosetting plastic or other insulation materials are used for manufacturing the shapes of the insulating encapsulator 202. A winding machine or a stamping machine, for example, can be used to form the coils 2011 of the coil module 20.

During operation of transformers, heat is generated and usually the encapsulator 202 hinders heat dissipation. To solve such problem, an amount of heat conductive powder, e.g. ceramic powder, is mixed into the encapsulator 202. Such coil modules with good property of heat dissipation can be utilized in printed circuit board or other applications as mentioned below.

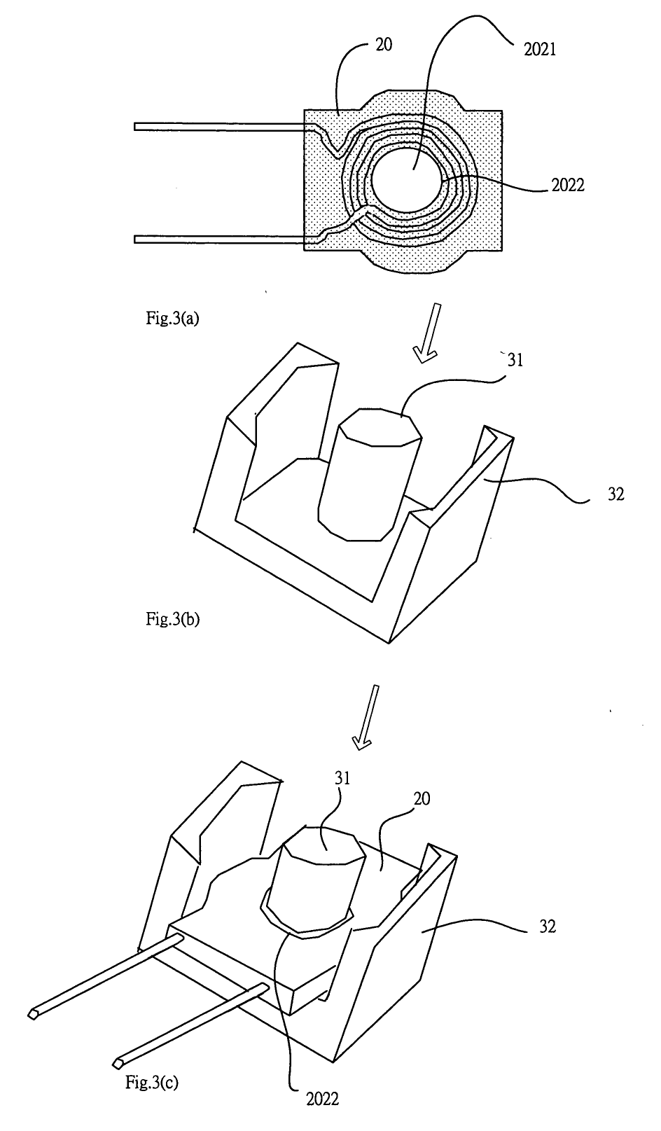

Please refer to FIGS. 3(a) to 3(c), which show how to assemble the coil modules 20 into a transformer. A metal core 31 is set on the base 32. The coil module 20 is put around the metal core 31 through the core opening 2021 so that the outline 2022 of the core opening 2021 surrounds the metal core 31.

Usually, a transformer has two or more coils. The coils for inputting voltage are called the primary coils. The coils for outputting a resultant voltage from an electromagnetic reaction are called the secondary coils. By adjusting the loop numbers of the primary coils and the secondary coils, a transformer meeting a specific requirement is obtained. The coil modules 20 with different loop numbers can be manufactured in advance. For example, coil modules 20 of loop numbers 4, 5, 6, . . . , 100 are manufactured and tested. The coiling process is dramatically simplified. Coiling in a transformer with specific requirements only requires selecting coil modules 20 of necessary loop numbers and installing these coil modules 20 into the transformer or a printed circuit board.

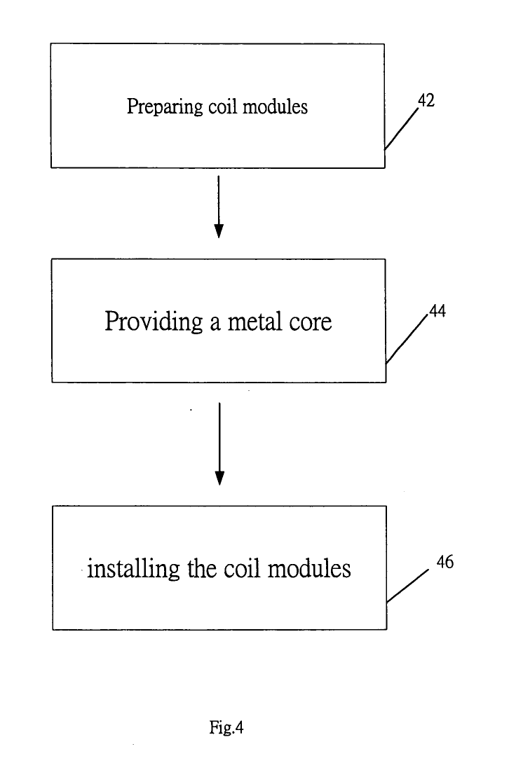

In conclusion, an embodiment for manufacturing a transformer includes the following steps, with reference to the flowchart in FIG. 4. Firstly, the coil modules 20 are prepared (step 42). The coil modules 20 of particular loop numbers are produced in advance as standard elements. Next, the metal core 31 as shown in FIG. 3(b) is provided (step 44). Then, the coil modules of necessary loops are selected and installed in the transformer (step 46) so that the outline 2022 of the core opening 2021 of the coil modules surrounds the metal core 31 as shown in FIG. 3(a) to FIG. 3(c).

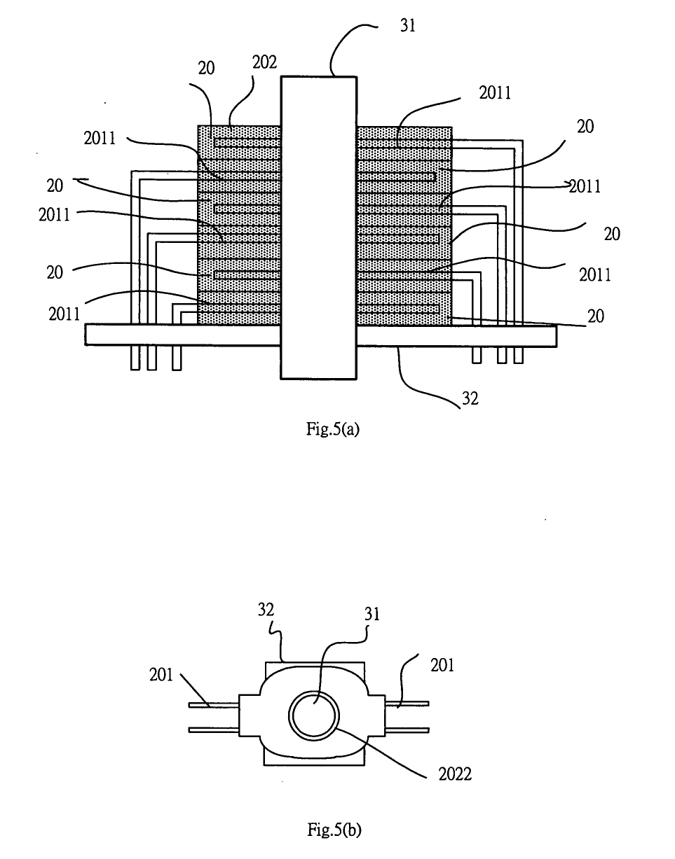

The coil modules 20 are arranged as a stack when they are installed in the transformer as shown in FIG. 5(a) and FIG. 5(b). FIG. 5(b) is a top view of FIG. 5(a). The coil 2011 of the coil module 20 is encapsulated with the insulating encapsulator 202. Therefore, the coils 2011 of each coil 20 are separated by the insulating encapsulator 202. In other words, the distance between coils 2011 of two adjacent coil modules 20 is controlled by the thickness of the insulating encapsulators 202 of the two adjacent coil modules 202.

In addition, the coil module 20 only has coverage on the coils 2011. To prevent the unencapsulated part of conductive wires 201 of two adjacent coil modules 20 from getting too close, the edges of adjacent coil modules 20 point to different directions as shown in FIG. 5(a) and FIG. 5(b). In this example, the edges of the coil modules 20 of the primary coils are therefore arranged with different direction from that of the edges of the coil modules 20 of the secondary coils. However, the edges of the primary coil and the secondary coils can be arranged in a same direction if the coil modules 20 according to the present invention are applied to a larger transformer or the distance between conductive wires 201 is enough.

In the example shown in FIG. 2(a), each loop of the coils 2011 of the coil module 20 is placed on essentially the same plane. In other words, each loop extends from the coil opening 2012 to avoid overlapping with other loop. Such design reduces the height of each coil module and therefore reduces the height of the transformers. Nevertheless, loops of coils 2011 of one coil module 20 overlapping with others are also within the boundary of the present invention.

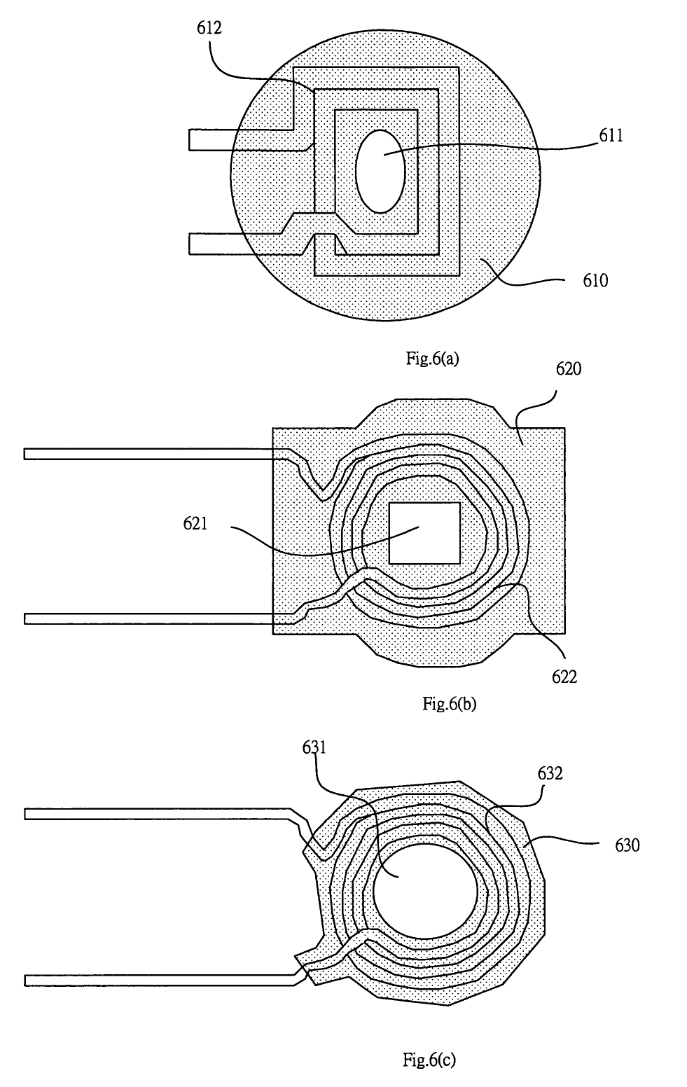

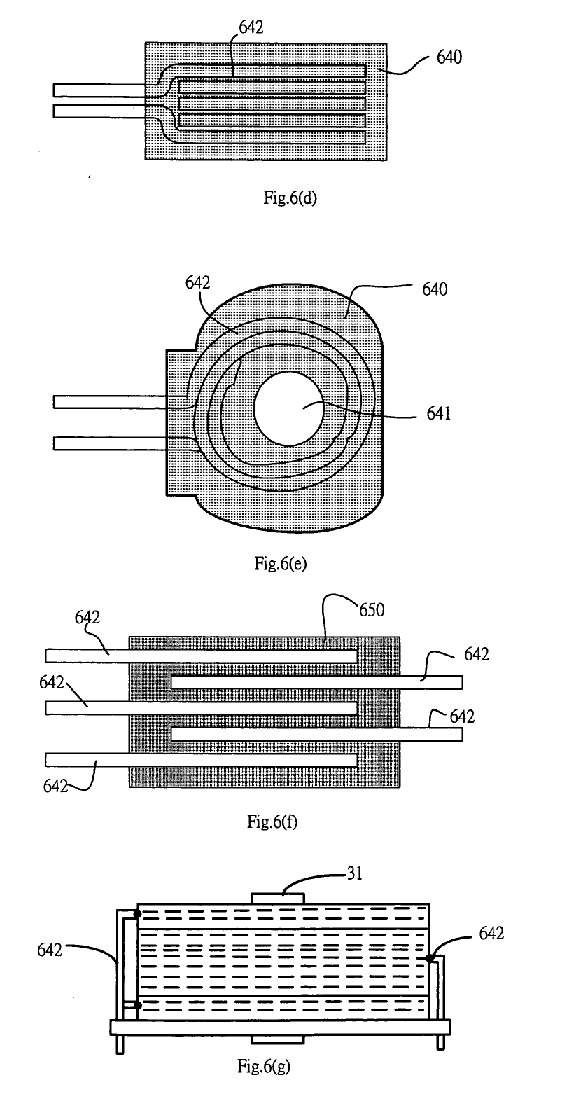

Also, the shapes of the insulating encapsulator 202, the core opening 2021, and the coils 2011 in FIG. 2(a) are adjustable according to the needs of the designer. The insulating encapsulators 610, 620, 630, the core openings 611, 621, 631 and coils 612, 622, 632 in FIG. 6(a) to FIG. 6(c) are variants of corresponding insulating encapsulators 201, core openings 2021, and the coils 2011 in FIG. 2(a).

In addition, to satisfy certain requirement, loops of the conductive wire in the coil module overlap each other as a stack. Of course, in each horizontal plane, these loops can be wound spirally at the same time. FIG. 6(d) and FIG. 6(e) show such coil modules. An encapsulator 640 encapsulates a coil 642, and the encapsulator 640 has a core opening for installing to a core.

In addition, the number of conductive wires 20 is adjustable according to the needs of the designer and need not be limited to one single conductive wire 201 as shown in the above example. For example, embedding a set of primary coils and secondary coils into one coil module 20 is within the boundary of the present invention. Further, any number of the conductive wire can be encapsulated by one encapsulator to form one coil module. For example, in FIG. 6(f), the encapsulator 650 encapsulates five independent coils composed of five independent conductive wires 642. FIG. 6(g) shows a transformer having the coil modules as shown in FIG. 6(f).

Furthermore, the coil modules 20 depicted in FIG. 2(a) and FIG. 5(a) are stacked directly because the insulating encapsulator 202 encapsulates the coils 2011. However, inserting certain insulation objects, such as an insulation ring, between coil modules 20 is also within the boundary of coil module stack of the present invention.

Additionally, the loop number and conductive wire characteristic of the coil module 20 are predetermined so that the cost is reduced by mass production. In addition, series connection or parallel connection of coil modules 20 solves the problem that special types of coil modules 20 are not available on the predetermined list.

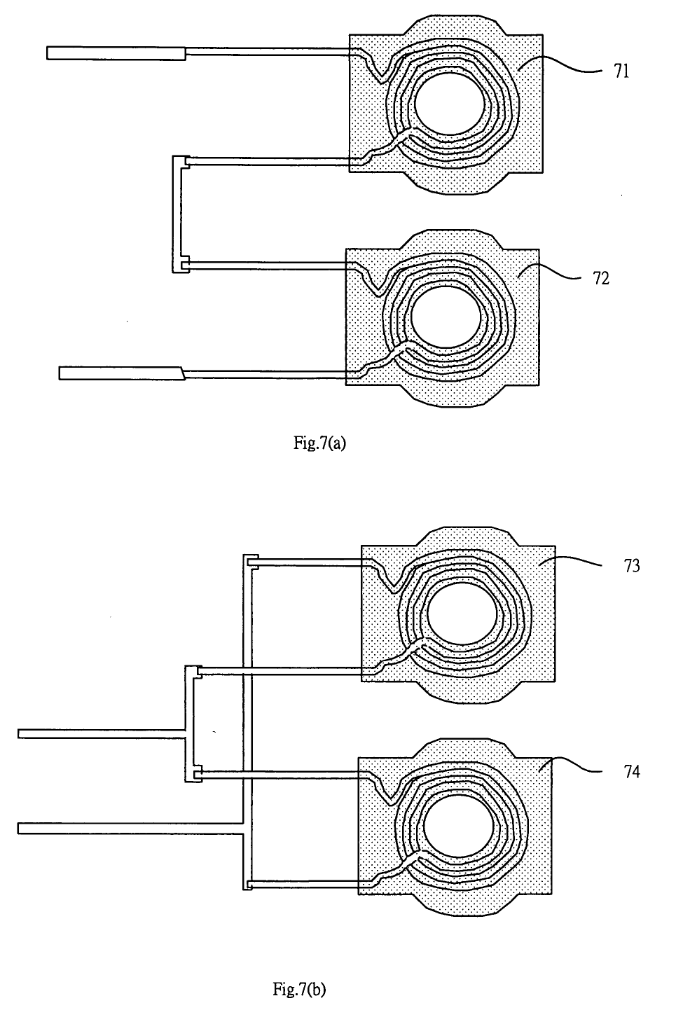

Please refer to FIG. 7(a) and FIG. 7(b). FIG. 7(a) shows a series connection of coil modules 71, 72 for higher loop number of coils, and FIG. 7(b) shows a parallel connection of coil modules 73, 74 for coils to sustain larger voltage or to prevent Skin Effect when frequency is lowered down.

### SECOND PREFERRED EMBODIMENT

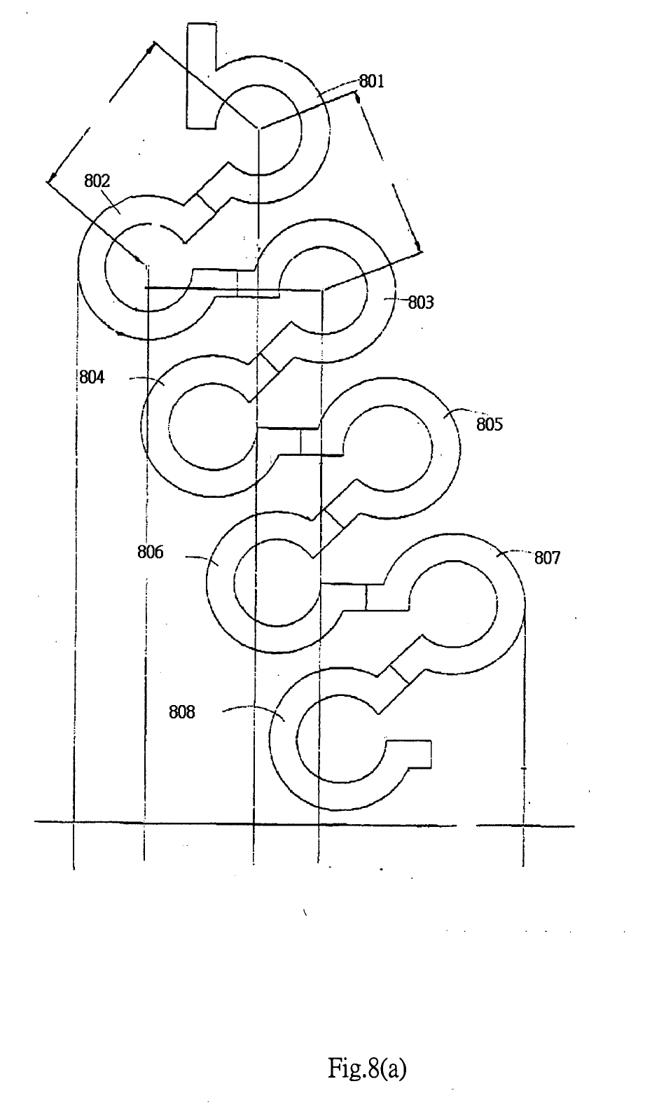

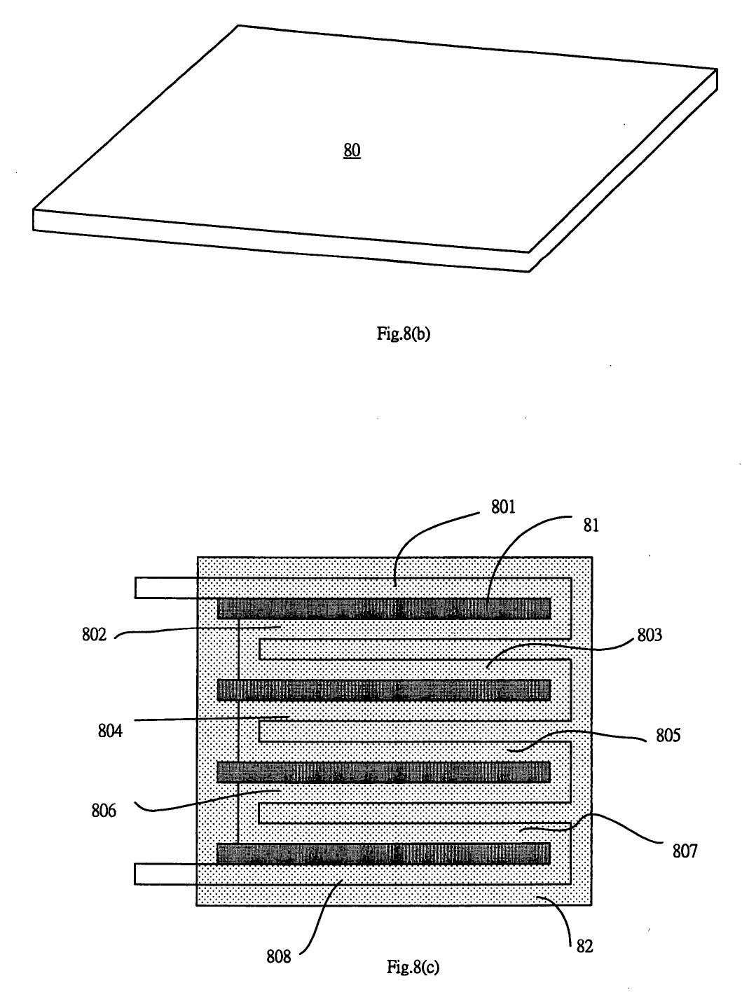

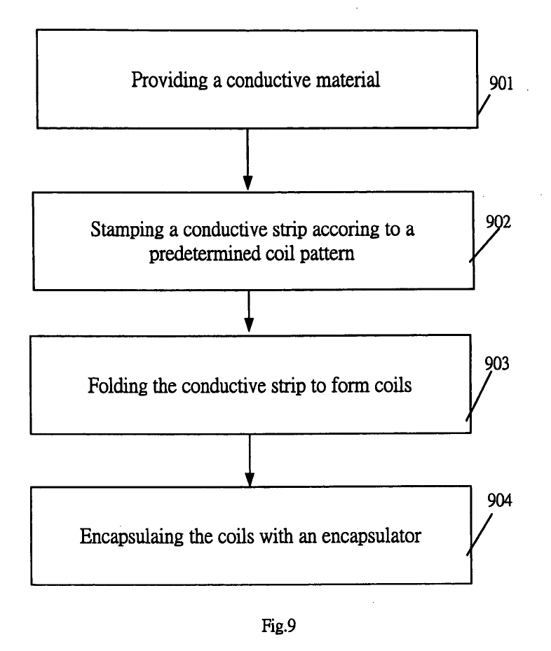

Please refer to FIGS. 8(a), (b), (c), and FIG. 9. FIGS. 8(a), (b), (c) illustrate another method to implement the coil modules according to the present invention, and FIG. 9 is a flow chart illustrating a flowchart of such method.

Firstly, a coil pattern is determined according to a requirement. FIG. 8(a) shows one coil pattern example which has eight loops of coils. Next, a conductive material, like copper, aluminum, or other conductive alloy, is chosen (step 901). Then, a stamping machine is utilized to produce a conductive strip according to the coil pattern assigned (step 902). The conductive strip has a coil portion having a certain number of coil loops. In FIG. 8(a), there are eight coil portions, 801, 802, 803, 804, 805, 806, 807, and 808. When the coil portions are folded as a stack, a coil opening is defined by the folded coil portions. In other words, the conductive strip is used as the conductive wire of the coil modules in the first preferred embodiment

Next, the eight coil portions 801-808 are folded as the stack (step 903), and insulating material 81, e.g. an insulating spacer, is added between the eight coil portions 801-808, as shown in FIG. 8(c). Then, an encapsulator 82 is used for encapsulating the eight coil portions 801-808 to form one coil module.

Besides, in this illustrating example, the conductive strip is folded as a stack to form the coils in the coil module. However, the conductive strip can also be stamped to form coils that are spirally winded directly. Therefore, in such situation, it is not necessary to fold the conductive strip to form the coil modules.

Of course, a certain amount of heat conducting powder, e.g. ceramic powder, can be added to the encapsulator 82 for heat dissipation. In addition, more then one conductive strip can be encapsulated in one coil module.

The manufacturing method mentioned above is particularly efficient for mass production of transformers satisfying certain specifications. The cost is lowered down, the manufacturing speed is accelerated while high quality of products is still kept.

### THIRD PREFERRED EMBODIMENT

In the two embodiments above, the coil modules are stacked around the coil as main units of the transformers. However, the coil module can also be arranged horizontally in a substantial same plane, while the coil modules are arranged in concentric circles.

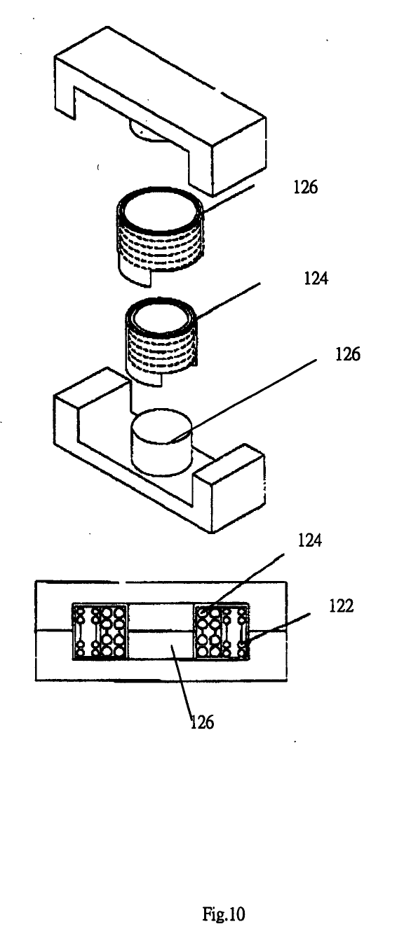

Reference is now made to FIG. 10, which illustrates an external coil module 122 and an inner coil module 124 being arranged around the core 126 in concentric circles. With such arrangement, further improvement on the height of transformers is obtained. This characteristic is particularly important for various electronic devices having strict height limitations.

Of course, More then two coil modules arranged in concentric circles. Actually, the number of the coil modules is only determined by the specifications of the transformers. In other words, more then two coil modules can be placed on a substantially same plane while outer coil modules surround inner coil modules.

In addition, all variants and implementing method can also be applied in this embodiment. For example, conducive strips produced by stamping process can be used in this embodiment.

In conclusion, it is apparent from the above description that the present invention has at least following advantages. Firstly, the flexibility and convenience of the coil modules greatly decrease the cost of manufacturing transformers. Secondly, the coils are protected by the insulating encapsulators and prevent damage during transformer manufacturing. Thirdly, the distance between coils in two adjacent coil modules is precisely and easily controlled by adjusting the thickness of the insulating encapsulators of the two adjacent coil modules. Also, the height of the transformers is reduced because the coil modules can be stacked directly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transformer comprising:
a metal core; and
a plurality of coil modules, each coil module having a predetermined loop number of coils and an encapsulator comprising plastic material for encapsulating the coils;
wherein a portion of the coils of the plurality of coil modules function as primary coils while other portion of the coils of the plurality of coil modules function as secondary coils, and the plurality of coil modules are stacked one on another and each coil module surrounds the metal core.

2. The transformer of claim 1, wherein the coils of each coil module are of a wound portion of at least one conductive wire.

3. The transformer of claim 1, wherein the coils of each coil module are of a coil-shape portion of at least one conductive strip.

4. The transformer of claim 1, wherein the coils are arranged in a substantially same plane.

5. The transformer of claim 1, wherein the coils are arranged as a stack of coils.

6. The transformer of claim 1, wherein a group of coil modules are connected in series or parallel.

7. The transformer of claim 1, wherein the insulating encapsulator is mixed with heat conductive material.

8. The transformer of claim 7, wherein the heat conductive material comprising ceramic powder.

9. The transformer of claim 1, wherein there are a plurality of conductive wires in one coil module and the coils of these conductive wires are separated by the encapsulator.

10. A transformer comprising:
a metal core; and
a plurality of coil modules, each coil module having a predetermined loop number of coils and an encapsulator comprising plastic material for encapsulating the coils;
wherein a portion of the coils of the plurality of coil modules function as primary coils while other portion of the coils of the plurality of coil modules function as secondary coils, and the plurality of coil modules are arranged in concentric circles surrounding the metal core.

11. The transformer of claim 10, wherein the coils of each coil module are of a wound portion of at least one conductive wire.

12. The transformer of claim 10, wherein the coils of each coil module are of a coil-shape portion of at least one conductive strip.

13. The transformer of claim 10, wherein the coils are arranged in a substantially same plane.

14. The transformer of claim 10, wherein the coils are arranged as a stack of coils.

15. The transformer of claim 10, wherein a group of coil modules are connected in series or parallel.

16. The transformer of claim 10, wherein the insulating encapsulator is mixed with heat conductive material.

17. The transformer of claim 16, wherein the heat conductive material comprising ceramic powder.

18. The transformer of claim 10, wherein there are a plurality of conductive wires in one coil module and the coils of these conductive wires are separated by the encapsulator.

19. A coil module comprising:
a predetermined loop number of coils, the predetermined loop number being selected from a predetermined set; and
an insulating encapsulator comprising plastic material for encapsulating the coils and separating the coils from contact with other coils of another adjacent coil module when a plurality of the coil modules are installed in a transformer wherein a portion of the plurality of coil modules function as primary coils while another portion of the plurality of coil modules function as secondary coils.

20. A method for manufacturing a transformer comprising:
providing a metal core;
selecting a plurality of coil modules made in advance, wherein each coil module has a loop number of coils and an insulating encapsulator comprising plastic material for encapsulating the coils, and the selection of the coil modules is made according to the loop number of coils of the plurality of coils modules; and
stacking the plurality of coil modules one on another to surround the metal core wherein a portion of the coils of the plurality of coil modules function as primary coils and other portion of the coils of the plurality of coil modules function as secondary coils.

21. The method of claim 20, further comprising a step of making groups of the coil modules, each group differentiated by the loop number of coils embedded in one coil modules.

22. The method of claim 21, wherein in the step of making the groups of the coil modules, the coil in each coil module are arranged into a stack of coils.

23. The method of claim 21, wherein in the step of making the groups of the coil modules, the coils in each coil module are obtained by winding at least one conductive wire.

24. The method of claim 21, wherein in the step of making the groups of the coil modules, the coils in each coil module are a portion of at least one conductive strip.

25. The method of claim 24, wherein the portion of the conductive strip is folded to form the coils in each coil module.

26. The method of claim 24, wherein in the step of making the groups of the coil modules, the conductive strip is made by stamping a conductive material according to a coil pattern.

27. The method of claim 21, wherein in the step of making the groups of the coil modules, heat conductive material is mixed in the encapsulator.
